(19) United States
(12) Patent Application Publication
(10) Pub. No.: US 2025/0390562 A1
(43) Pub. Date: Dec. 25, 2025

(54) IMAGE FORMING APPARATUS

(71) Applicant: Toshiba Tec Kabushiki Kaisha, Tokyo (JP)

(72) Inventor: Masaru KOGA, Mishima (JP)

(73) Assignee: Toshiba Tec Kabushiki Kaisha, Tokyo (JP)

(21) Appl. No.: 19/085,054

(22) Filed: Mar. 20, 2025

(30) Foreign Application Priority Data
Jun. 20, 2024 (JP) 2024-099935

(51) Int. Cl. G06F 21/12

(52) U.S. Cl. CPC G06F 21/121

(57) ABSTRACT

An image forming apparatus can include a first memory configured to store at least one program. The image forming apparatus can include a second memory configured to store a whitelist comprising one or more listed programs and unique information for each listed program. The image forming apparatus can include a processor configured to, when the first program requesting to be executed is different than the unique information in the whitelist, rewrite the first program with an original program and restart the image forming apparatus.

### CROSS-REFERENCE TO RELATED APPLICATION

This application is based upon and claims the benefit of priority from Japanese Patent Application No. 2024-099935, filed on Jun. 20, 2024, the entire contents of which are incorporated herein by reference.

### FIELD

Embodiments described herein relate generally to an image forming apparatus.

### BACKGROUND

An image forming apparatus, such as a digital multifunction peripheral, is configured such that processor can execute various programs to perform various processes. In recent years, in image forming apparatuses such as the digital multifunction peripheral, a large number of programs are being installed, corresponding to an increase in the number of functions. Such image forming apparatuses have risks such as an unauthorized program being installed illegally or a legitimate program being illegally rewritten.

An image forming apparatus of the related art is provided with a whitelist type anti-malware function that controls program execution based on a whitelist to act against unauthorized programs. When executing a program or loading a library, the image forming apparatus checks whether a hash value thereof matches a hash value in the whitelist. When a program whose hash value does not match is detected, the image forming apparatus of the related art stops processing of the image forming apparatus. Therefore, the image forming apparatus of the related art has a problem in that operations stop upon detecting a program whose hash value does not match with the whitelist.

### DESCRIPTION OF THE DRAWINGS

FIG. 1 is a diagram showing a configuration example of an image forming system including a digital multifunction peripheral as an image forming apparatus according to an embodiment;

FIG. 2 is a block diagram showing a configuration example of the digital multifunction peripheral;

FIG. 3 is a table showing an example of a whitelist for legitimate programs stored in the digital multifunction peripheral; and

FIG. 4 is a flowchart for describing an operation example of a validity check process by the digital multifunction peripheral.

### DETAILED DESCRIPTION

Embodiments provide an image forming apparatus that can operate safely without stopping an operation when illegality of a program (e.g., an unauthorized program) is detected.

In general, according to one embodiment, an image forming apparatus includes a first memory, a second memory, and a processor. The first memory is configured to store a program. The second memory is configured to store a whitelist including unique information for each listed program. The processor is configured to, when a first program requesting to be executed is different than the unique information registered in the whitelist, rewrite the first program with an original program and restart the image forming apparatus.

Hereinafter, an exemplary embodiment will be described with reference to the drawings.

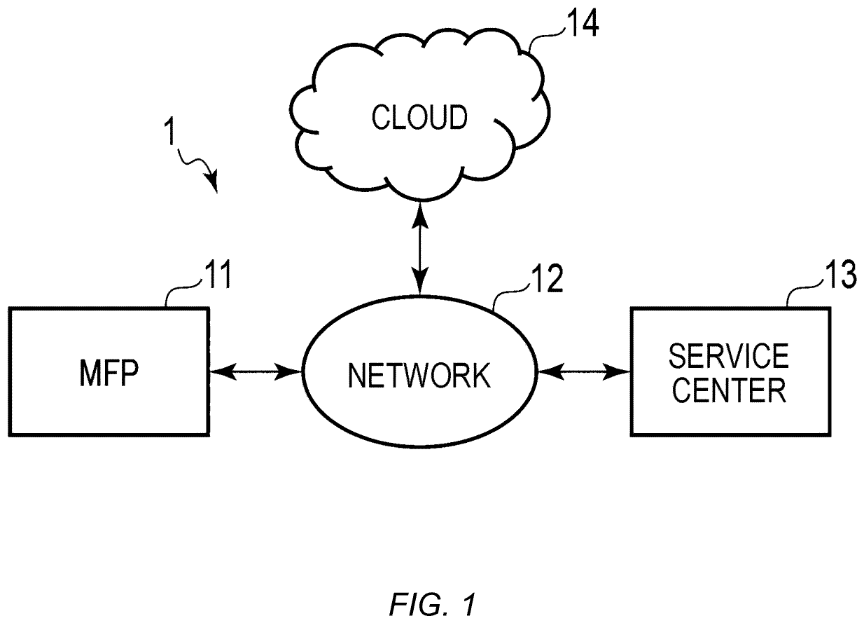

FIG. 1 is a diagram showing a configuration example of an image forming system 1 including a digital multifunction peripheral (MFP) (e.g., device) 11 as an image forming apparatus according to one or more embodiments.

The image forming system 1 has a configuration in which the digital multifunction peripheral (MFP) as the image forming apparatus is connected to a service center 13 and a cloud 14 via a network 12.

The service center 13 includes a server that communicates with the digital multifunction peripheral 11. The service center 13 performs maintenance and management of the digital multifunction peripheral 11 that is communicable via the network 12. For example, the service center 13 includes a server that notifies a repair person who performs maintenance on the digital multifunction peripheral 11 of information indicating a state of the digital multifunction peripheral 11.

The cloud 14 includes various servers communicable with the digital multifunction peripheral 11. The cloud 14 includes a server that stores data used in the digital multifunction peripheral 11. For example, the cloud 14 includes a server used by a cloud service application installed in the digital multifunction peripheral 11. Cloud services that can be used by the digital multifunction peripheral 11 include provision of processing such as processing for scan data and management of printer data. The cloud 14 may also include a server that securely stores an original program of a program installed in the digital multifunction peripheral 11.

The digital multifunction peripheral 11 is an example of an image forming apparatus. The digital multifunction peripheral 11 includes not only a printer but also a scanner and an operation panel. The digital multifunction peripheral 11 according to one or more embodiments executes various programs to execute various processes. The programs installed in the digital multifunction peripheral 11 include not only programs stored in a read-only memory but also programs stored in a rewritable storage device (storage). For example, the storage of the digital multifunction peripheral 11 may store an application program or the like for performing special processing on image data.

Subsequently, a configuration of the digital multifunction peripheral 11 as the image forming apparatus according to at least one embodiment will be described herein.

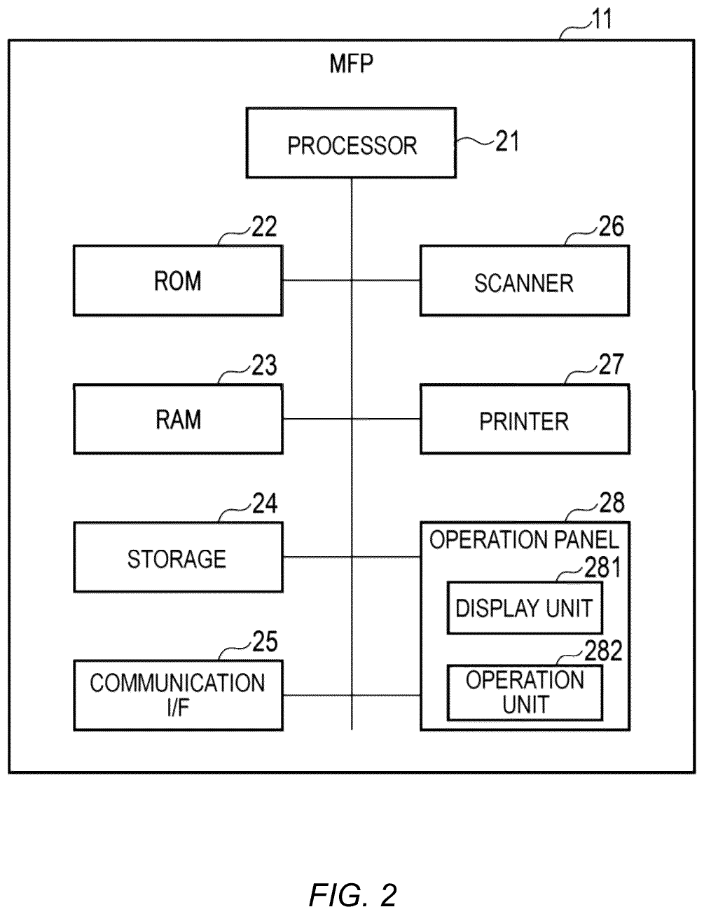

FIG. 2 is a block diagram showing a configuration example of the digital multifunction peripheral (MFP) 11 as the image forming apparatus according to at least one embodiment.

As shown in FIG. 2, the digital multifunction peripheral 11 includes at least a processor 21, a read-only memory (ROM) 22, a random access memory (RAM) 23, a storage 24, a communication interface (I/F) 25, a scanner 26, a printer 27, and an operation panel 28.

The processor 21, the ROM 22, the RAM 23, the storage 24, and the communication interface 25 configure a system controller of the digital multifunction peripheral 11. The system controller is connected to the scanner 26, the printer 27, and the operation panel 28. The system controller is a computer that executes general operation control of each unit and various data processing in the digital multifunction peripheral 11.

The processor 21 controls the digital multifunction peripheral 11. The processor 21 executes data processing such as various arithmetic processing. The processor 21 executes a program to execute control of each unit and data processing. The processor 21 is, for example, a CPU. The processor 21 is connected to each unit in the digital multifunction peripheral 11 via an internal interface. For example, the processor 21 uses the RAM 23 to execute programs stored in the ROM 22 or the storage 24, thereby executing various processing.

The ROM 22 is a read-only memory. The ROM 22 is a non-volatile memory in which data cannot be rewritten. The ROM 22 stores at least the original program and control data that are set in advance. The ROM 22 may be plural, or may include a PROM in which data can be written in a specific procedure. For example, the ROM 22 may include a ROM for storing a system operation program and control data and a dedicated ROM (read-only memory) for storing the original program.

The RAM 23 is a volatile memory. The RAM 23 functions as a working memory or a buffer memory. For example, the RAM 23 loads a program to be executed by the processor 21 and temporarily stores data being processed.

The storage 24 is configured with a rewritable non-volatile memory. For example, the storage 24 is configured with a hard disk drive (HDD), a solid state drive (SSD), a flash memory, and the like. The storage 24 stores data such as programs, control data, and setting information. The storage 24 includes a storage area for storing updatable programs (e.g., a first memory) and a storage area for storing setting information such as a whitelist (e.g., a second memory). For example, the storage area for storing a whitelist is a secure storage area in which modification by a third party is difficult.

The communication interface 25 is an interface for communicating with an external device. For example, the communication interface 25 is a network interface for communicating with the service center 13 or the cloud 14 via the network 12. The communication interface 25 may include at least one of an interface for wired communication or an interface for wireless communication.

The scanner 26 is a device that optically reads an image of a document. The scanner 26 reads the image of the document set on a document stand glass. The scanner 26 may be provided with an automatic document feeder (ADF). The scanner 26 provided with the ADF reads the image of the document conveyed by the ADF.

The printer 27 forms an image on a medium such as a sheet. For example, the printer 27 forms an image on a sheet received from a paper feed cassette that stores sheets. The printer 27 may be provided with an image forming mechanism of any image forming method. For example, in response to the printer 27 being provided with an electrophotographic image forming mechanism, the printer forms a developer image on an image carrier such as a photosensitive drum, and transfers the developer image on the image carrier to a sheet. In response to the printer 27 being provided with an inkjet image forming mechanism, the printer 27 forms an image on the sheet with ink ejected by an inkjet head.

The operation panel 28 is a user interface. The operation panel 28 includes a display unit 281 and an operation unit 282. The display unit 281 is configured with a display. The display unit 281 displays at least an operation guide or the like. The operation unit 282 includes a touch panel and a plurality of operation buttons. The touch panel of the operation unit 282 detects a portion touched by the user on the display screen of the display. The touch panel is provided, for example, on the display screen of the display unit 281. The operation buttons of the operation unit 282 are buttons for inputting specific operation instructions.

Subsequently, the whitelist stored in the digital multifunction peripheral 11 as the image forming apparatus according to at least one embodiment will be described herein.

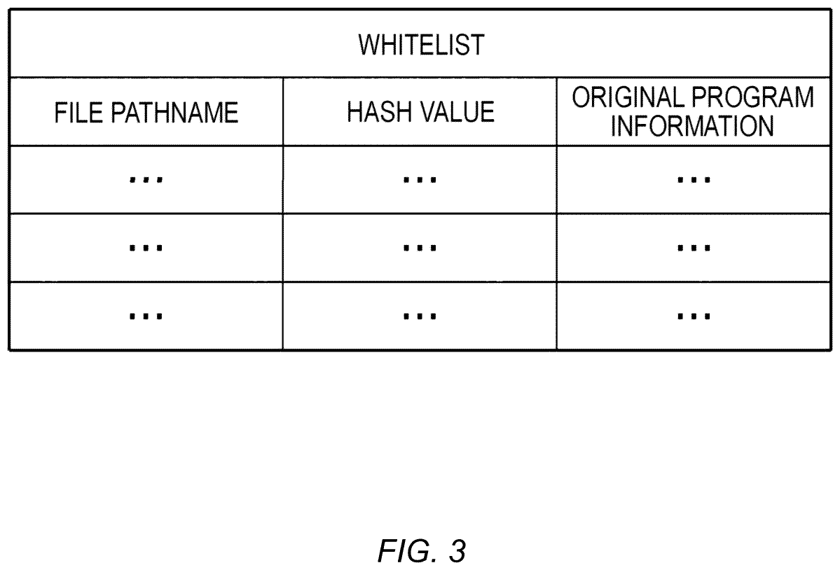

FIG. 3 is a diagram showing an example of the whitelist stored in the digital multifunction peripheral 11 as the image forming apparatus according to at least one embodiment.

The whitelist is information in which information for checking validity of a program is registered. The whitelist is information in which individual programs whose validity is to be checked are listed. In the whitelist, information as a legitimate program (e.g., listed program) is registered for each program.

The program whose validity is to be checked and registered in the whitelist is, for example, a program stored in the storage 24. The programs registered in the whitelist include, for example, firmware and application programs. The programs registered in the whitelist include, for example, application programs for providing services using the cloud 14. The programs registered in the whitelist may be programs that can be updated by a legitimate procedure.

In the example shown in FIG. 3, information such as a file pathname, a hash value, and original program information is registered for each program in the whitelist.

The whitelist as shown in FIG. 3 is stored in a storage area in which illegal (e.g., unauthorized) modification is difficult (e.g., second memory). For example, a whitelist of programs whose file pathnames or hash values can be changed by legitimate (e.g., authorized) updates is stored in a secure memory provided in the storage 24. A whitelist of programs whose file pathnames and hash values cannot be changed may be stored in the ROM 22.

In the whitelist illustrated in FIG. 3, the file pathname is information indicating a legitimate storage location of a file in which data of the legitimate program is stored. For example, as the file pathname, a pathname indicating a location in which data of a program is stored by a legitimate mechanism of the digital multifunction peripheral 11 is registered. Whether a program to be executed is an unauthorized program (e.g., malware) is determined depending on whether a file path of the program is registered in the whitelist.

In the whitelist illustrated in FIG. 3, the hash value is a value calculated using a hash function from legitimate program data of a program specified by the file pathname. Whether a program to be executed is valid is checked by determining whether a hash value calculated from data of the program matches (e.g., corresponds to) a hash value in the whitelist.

That is, the digital multifunction peripheral 11 performs hash check processing for detecting whether a program is modified using a hash value. For example, when the hash value of the program to be executed does not match (e.g., is different than) the hash value in the whitelist, it is determined that the program to be executed is modified. When a program is legitimately updated, the hash value registered in the whitelist is updated to a hash value of data of the updated program.

In the whitelist illustrated in FIG. 3, the original program information is information indicating an original program for a program specified by a file pathname. The original program information includes, for example, information indicating a storage location of data of the original program. The data of the original program is stored in the ROM 22 that is a read-only memory.

However, the data of the original program may be stored in a server communicable via the network 12. Then, the original program information may indicate access information for accessing the server storing the original program. The server that stores the original program is capable of securely storing data and securely communicating with the digital multifunction peripheral 11. For example, the server that stores the original program is assumed to be a server provided in the service center 13, a server provided in the cloud 14, or the like.

Subsequently, a program validity check process using a whitelist in the digital multifunction peripheral 11 as the image forming apparatus according to at least one embodiment will be described herein.

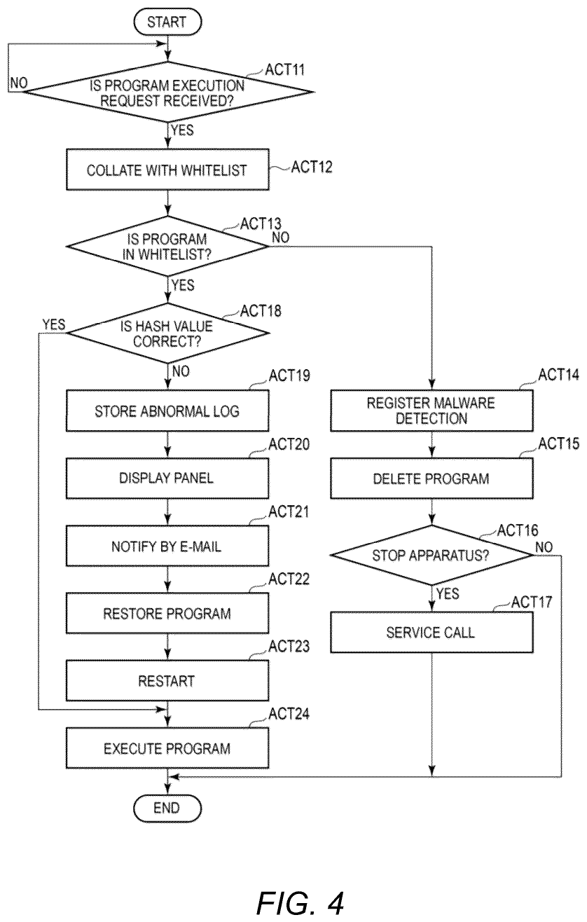

FIG. 4 is a flowchart for describing an example of the program validity check process in the digital multifunction peripheral 11 as the image forming apparatus according to at least one embodiment.

In the digital multifunction peripheral 11, the processor 21 receives a request to execute a program to be checked by a user operation or processing by a specific program (ACT 11). Responsive to the processor 21 receiving the request to execute the program, the processor 21 checks a validity of the program requesting to be executed.

When the request to execute the program is received (YES in ACT 11), the processor 21 collates (e.g., receives) the program requesting to be executed with information registered in the whitelist (ACT 12). First, the processor 21 collates the whitelist and determines whether the program requesting to be executed is in the whitelist (ACT 13). For example, the processor 21 collates a path of the program requesting to be executed with a file pathname registered in the whitelist. The processor 21 determines whether the program requesting to be executed is present depending on whether the file pathname that matches the path of the program requesting to be executed is in the whitelist.

When the program requesting to be executed is not in the whitelist (NO in ACT 13), the processor 21 detects the program as an unauthorized program (e.g., malware). When the program requesting to be executed is detected as malware, the processor 21 stores detection of the malware as log (e. g., history) data (ACT 14). For example, the processor 21 stores information about the program detected as malware in the storage 24 as a malware detection log.

When the program requesting to be executed is detected malware, the processor 21 executes processing for as deleting the program detected as malware. For example, the processor 21 deletes data of the program detected as malware from the storage.

When the program detected as malware is deleted, the processor 21 determines whether to stop operations of the digital multifunction peripheral 11 (ACT 16). For example, an operation to be executed after deleting the program detected as malware is assumed to be set in advance. The processor 21 determines, based on the preset setting, the operation to be executed after deleting the program detected as malware.

Here, whether the digital multifunction peripheral 11 stops the operation and notifies the service center (service call) or continues the operation after deleting the malware is assumed to be set in advance (e.g., preconfigured, preset). Here, the processor 21 determines, based on the preset setting, whether to make a service call or to enable the operation after deleting the malware.

Responsive to the processor 21 determining to stop the operation and make the service call when the malware is deleted (YES in ACT 16), the processor 21 stops the operation of the digital multifunction peripheral 11. The processor 21 executes a service call to notify the service center 13 of information about the program detected as malware (the deleted program) while the operation is stopped (ACT 17). The service center 13 can confirm, by the service call, that the digital multifunction peripheral 11 deleted the program detected as malware and is stopping operation. When the service call is received, the service center 13 executes a procedure for resuming the operation of the digital multifunction peripheral 11.

Responsive to the processor 21 determining to continue the operation after the malware is deleted (NO in ACT 16), the processor 21 ends a series of processing in response to a request to execute the program deleted as malware. Here, after detecting and deleting the malware, the processor 21 may restart the digital multifunction peripheral 11 and then continue the operation. The processor 21 may allow the digital multifunction peripheral 11 to continue the operation and notify the user or the service center 13 that the program detected as malware is deleted.

In response to the program requesting to be executed being in the whitelist (YES in ACT 13), the processor 21 executes hash check of the program (ACT 18). In the hash check, the processor 21 calculates a hash value of the data of the program requesting to be executed. For example, the processor 21 loads the data of the program requesting to be executed in the RAM 23. The processor 21 applies a hash function to the data of the program loaded in the RAM 23 to calculate the hash value of the data.

The processor 21 specifies, from the whitelist, a hash value of a program whose file pathname matches the program requesting to be executed. The processor 21 determines whether the hash value of the program requesting to be executed matches the hash value registered in the whitelist.

When the hash value of the program requesting to be executed matches the hash value in the whitelist (YES in ACT 18), the processor 21 determines that the validity of the program is confirmed. When the validity of the program requesting to be executed is confirmed, the processor 21 executes the program (ACT 24).

When the hash value of the program requesting to be executed does not match the hash value in the whitelist (NO in ACT 18), the processor 21 determines that the program was modified. When modification of the program requesting to be executed is detected, the processor 21 stores abnormality log data in the storage 24, in which the log data indicates that modification of the program is detected (ACT 19).

When modification of the program requesting to be executed is detected, the processor 21 displays a guide (e. g., warning) on the display unit 281 of the operation panel 28, in which the guide indicates that modification of the program is detected (ACT 20). When modification of the program requesting to be executed is detected, the processor 21 notifies a predetermined contact that modification of the program is detected (ACT 21). For example, the processor 21 notifies an administrator set in advance in the digital multifunction peripheral 11 by e-mail or the like that modification of the program is detected. The processor 21 may also notify the service center 13 via the communication interface 25 that modification of the program is detected.

When modification of the program requesting to be executed is detected, the processor 21 does not execute the program and restores (e.g., replaces, rewrites) the program with an original program thereof (ACT 22). For example, the processor 21 reads, from the whitelist, original program information indicating an original program of the program in which modification is detected.

The processor 21 specifies the storage location of the data of the original program indicated by the original program information. The data of the original program is stored in a memory in which data can be safely stored without being rewritten. For example, the data of the original program is stored in the ROM 22 that is a read-only memory provided in the digital multifunction peripheral 11.

The storage location of the data of the original program may be an external device (e.g., the service center 13 or the cloud 14) communicable with the digital multifunction peripheral 11 via the network 12. Then, the original program information indicates information for accessing the external device that stores the data of the original program.

For example, when the data of the original program is stored in a server of the service center 13, the original program information indicates access information to the server of the service center 13. The processor 21 accesses the server of the service center 13 using the access information indicated by the original program information and acquires the data of the original program.

When the data of the original program is stored in a server of the cloud 14, the original program information indicates access information to the server that stores the data of the original program in the cloud 14. The processor 21 acquires the data of the original program from the server of the cloud 14 using the access information indicated by the original program information.

Responsive to the storage location of the data of the original program being specified, the processor 21 acquires the data of the original program from the storage location. Responsive to the data of the original program being acquired, the processor 21 rewrites the data of the program in which modification is detected with the data of the original program. As a result, the program in which modification is detected is restored with the original program indicated by the original program information.

When the program in which modification is detected is rewritten with the original program, the processor 21 restarts the digital multifunction peripheral 11 (ACT 23). When the digital multifunction peripheral 11 is restarted after the program is restored, the processor 21 executes the program restored with the original program (ACT 24). Here, the processor 21 may display on the display unit 281 that the program in which modification is detected was restored with the original program. The processor 21 may notify the service center 13 that the program in which modification is detected was restored with original program.

However, responsive to the processor 21 restoring the program and restarting the digital multifunction peripheral 11, the processor 21 may execute the restored program in response to an instruction of a user. For example, when the digital multifunction peripheral 11 is restarted, the processor 21 displays a selection guide screen for asking whether to execute the restored program on the display unit 281, and receives an instruction of a user. Then, the processor 21 may execute the restored program when the user instructs the processor to execute the restored program.

As described above, the digital multifunction peripheral as the image forming apparatus according to at least one embodiment stores the whitelist indicating the hash values in the legitimate programs. The digital multifunction peripheral checks whether the hash value of the program requesting to be executed matches the hash value registered in the whitelist. Responsive to the hash value of the program requesting to be executed being different than the hash value registered in the whitelist, the digital multifunction peripheral rewrites the program requesting to be executed with the original program and is restarted.

As a result, responsive to the hash value of the program being different than the hash value in the whitelist, the digital multifunction peripheral can restore the program with the original program. The digital multifunction peripheral can continue to operate after the program whose hash value does not match the hash value registered in the whitelist is restored with the original program.

The digital multifunction peripheral as the image forming apparatus according to at least one embodiment stores the whitelist indicating the file pathnames and the hash values in the legitimate programs. Responsive to a file pathname that matches file path of the program requesting to be executed being not in the whitelist, the digital multifunction peripheral deletes the program requesting to be executed. The digital multifunction peripheral specifies a hash value of the program that matches the file path of the program requesting to be executed from the whitelist. Responsive to the hash value specified from the whitelist not matching the hash value of the program requesting to be executed, the digital multifunction peripheral restores the program with the original program.

As a result, responsive to the file path of the program requesting to be executed being not in the whitelist, the digital multifunction peripheral can delete the program as malware. The digital multifunction peripheral can perform the hash check responsive to the file path of the program requesting to be executed being in the whitelist. As a result, the digital multifunction peripheral can delete a program suspected as malware, and can restore a program suspected to be modified with the original program to continue operation.

The digital multifunction peripheral as the image forming apparatus according to at least one embodiment includes the read-only memory that stores the original program. The digital multifunction peripheral restores a program whose hash value does not match the hash value registered in the whitelist with the original program stored in the read-only memory.

As a result, the digital multifunction peripheral can restore the program whose hash value does not match the hash value registered in the whitelist with the original program stored in the read-only memory and continue operation.

The digital multifunction peripheral as the image forming apparatus according to at least one embodiment includes a communication interface for communicating with an external device that stores the original program. The digital multifunction peripheral acquires, from the external device, data of the original program corresponding to the program whose hash value does not match the hash value registered in the whitelist. The digital multifunction peripheral restores the program whose hash value does not match the hash value registered in the whitelist with the original program acquired from the external device.

As a result, the digital multifunction peripheral can restore the program whose hash value does not match the hash value registered in the whitelist with data acquired from the external device and continue operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a first memory configured to store at least one program;
a second memory configured to store a whitelist comprising one or more listed programs and unique information for each listed program; and
a processor configured to, when a first program requesting to be executed is different than the unique information in the whitelist, rewrite the first program with an original program and restart the image forming apparatus.

2. The image forming apparatus according to claim 1, wherein
the unique information comprises a hash value of each listed program, and
responsive to a hash value of the first program being different than the hash value of each listed program registered in the whitelist, the processor rewrites the first program with the original program.

3. The image forming apparatus according to claim 1, further comprising:
a read-only memory configured to store the original program, wherein
the processor rewrites the first program with the original program stored in the read-only memory.

4. The image forming apparatus according to claim 1, further comprising:
a communication interface configured to communicate with an external device that stores the original program, wherein
the processor rewrites the first program with the original program acquired from the external device that communicates via the communication interface.

5. The image forming apparatus according to claim 1, wherein
the whitelist comprises information indicating a file pathname and the unique information for each listed program, and
responsive to a file path of the first program being different than the file pathname of each listed program in the whitelist, the processor deletes the first program, and
responsive to the file path of the first program matching the file pathname in the whitelist and a hash value of a second program specified by the matching file pathname in the whitelist is different than a hash value of the first program, the processor rewrites the first program with the original program.

6. The image forming apparatus according to claim 5, wherein an operation to be executed by the processor after deleting the first program is preset.

7. The image forming apparatus according to claim 6, wherein:
responsive to the processor being preset to stop operation of the image forming apparatus, the processor generates a notification, and
responsive to the processor being preset to continue the operation of the image forming apparatus, the processor restarts the image forming apparatus.

8. The image forming apparatus according to claim 1, wherein the at least one program stored in the first memory comprises the first program.

9. A method comprising:
storing, by one or more processors comprised in an image forming apparatus, in a first memory, at least one program;
storing, by the one or more processors, in a second memory, a whitelist comprising one or more listed programs and unique information for each listed program;
receive, by the one or more processors, a request for a first program to be executed;
rewrite, by the one or more processors, the first program with an original program responsive to determining that the unique information of the first program is different than the unique information in the whitelist; and
restart, by the one or more processors, the image forming apparatus.

10. The method according to claim 9, wherein
the unique information comprises a hash value of each listed program, and
responsive to a hash value of the first program being different than the hash value of each listed program registered in the whitelist, the one or more processors rewrite the first program with the original program.

11. The method according to claim 9, further comprising:
storing, by the one or more processors, in a read-only memory, the original program, wherein
the one or more processors rewrite the first program with the original program stored in the read-only memory.

12. The method according to claim 9, further comprising:
communicating, by the one or more processors, via a communication interface, with an external device that stores the original program, wherein
the one or more processors rewrite the first program with the original program acquired from the external device that communicates via the communication interface.

13. The method according to claim 9, wherein
the whitelist comprises information indicating a file pathname and the unique information for each listed program, and
responsive to a file path of the first program being different than the file pathname of each listed program in the whitelist, the one or more processors delete the first program, and
responsive to the file path of the first program matching the file pathname in the whitelist and a hash value of a second program specified by the matching file pathname in the whitelist is different than a hash value of the first program, the one or more processors rewrite the first program with the original program.

14. The method according to claim 13, wherein an operation to be executed by the one or more processors after deleting the first program is preset.

15. The method according to claim 14, wherein:
responsive to the one or more processors being preset to stop operation of the image forming apparatus, the one or more processors generate a notification, and
responsive to the one or more processors being preset to continue the operation of the image forming apparatus, the one or more processors restart the image forming apparatus.

16. The method according to claim 9, wherein the at least one program stored in the first memory comprises the first program.
